(19) United States
(12) Patent Application Publication
(10) Pub. No.: US 2009/0191934 A1
(43) Pub. Date: Jul. 30, 2009

(54) Skill Based Adaptation Of A Poker Game

(76) Inventor: Krister Larson, Studio City, CA (US)

Correspondence Address: Ashok Tankha;Of Counsel, Lipton, Weinberger & Husick, 36 Greenleigh Drive, Sewell, NJ, 08080, US

(21) Appl. No.: 12/018,819

(22) Filed: Jan. 24, 2008

(51) Int. Cl. A63F 13/00; A63F 1/00

(52) U.S. Cl. 463/13; 273/292

(57) ABSTRACT

Disclosed herein is a method and system for a skill based adaptation of a poker game. Each of a first player and a plurality of second players of the poker game are evaluated for correct play after bets are placed. The correct play of the first player and second players is determined based on making the second players of the poker game fold by the first player and also playing with a null or a positive expected value. The expected value is calculated based on bets placed by each of the first player and the second players, probability of winning the poker game by the first player and the second players, and sum of the bets placed. A predefined percentage of the bets placed is awarded to the first player and the second players for the correct play.

### BACKGROUND

This invention, in general, relates to casino games and specifically relates to a skill based adaptation of poker game.

There are a variety of casino games including spin games such as video slot machines, table games such as blackjack, four card poker, texas hold'em poker, pai gow poker, spanish 21, etc, dice or tiles games such as craps and sic bo, and random numbers games such as big six wheel and roulette. Casino games also include gaming machines and lottery-like games such as bingo and keno.

In spin games, no player decisions are required to affect the outcome of the game. The player simply makes a wager and performs an initial action such as pulling the handle of the slot machine or pressing the spin button. The probability of a player winning or losing a spin game is based on chance. The player has no control or input over the outcome of the spin game. In other casino games such as big six wheel and roulette the player has a modest input into the game. The player selects one or more numbers that the player hopes will occur during the play of the game. The winning numbers are randomly selected and the player wins if the numbers selected by the player match the randomly selected numbers. Although the player has an input into the game, the outcome of the game is not influenced by the player input or any decision made by the player.

Casino games such as four card poker, pai gow poker, texas hold'em, etc. require a player to provide continuous input into the game. Poker games are typically chance based games. A player may lose a poker game although the player exhibits skill by making all the correct decisions with respect to the cards dealt to the player. On the other hand a player may win a poker game even though the player made unwise decisions by virtue of the cards held by the player. For example, consider two players Alice and Bob involved in a texas hold'em poker game. Alice is dealt a pair of aces (AA) and Bob is dealt a pair of kings (KK). The community cards are 2-3-4-Q-K. Alice bets a thousand chips with AA. Bob calls the thousand chips bet by Alice. Alice played perfectly as AA is over a 4:1 favorite to win, yet lost because of luck. Bob wins two thousand chips and Alice is out of the tournament because of chance. Since the winning or losing of a poker game is not influenced by skill it can be classified as a predominantly chance based game. The decisions made by the player during the course of the game may or may not influence the outcome of the game.

There is a need for a method and system for a skill based adaptation of a poker game. Further, there is a need for ensuring the outcome of the poker game is dependent on playing skills of the players.

### SUMMARY OF THE INVENTION

The method and system disclosed herein is a skill based adaptation of a poker game. Each of a first player and a plurality of second players of the poker game are evaluated for correct play after bets are placed. The correct play of the first player and second players is determined based on making the second players of the poker game fold by the first player and also the first player and the second players playing with a null or a positive expected value. The expected value is calculated based on bets placed by each of the first player and the second players, probability of winning the poker game by the first player and the second players, and sum of the bets placed. A predefined percentage of the bets placed is awarded to the first player and the second players for the correct play. The step of awarding the first player and the second players for the correct play ensures the outcome of the poker game is dependent on playing skills of the first player and the second players.

The expected value of the first player and the second players is calculated as the difference of adjusted amount of bets collected and the bet amount of the player adjusted against the probability of the first player and the second players winning, losing or tying the poker game. The probability of the first player and the second players winning, losing or tying the poker game may be calculated by enumerating all possible outcomes of the poker game or for example, by using the Monte Carlo method. The Monte Carlo method involves iterating over random outcomes of the game for a predefined number of times. The Monte Carlo method randomly generates outcomes. When these outcomes are tracked over a number of iterations the final results are fairly accurate.

The poker game may continue for a predefined time or until one player has all the chips. Since some chips can only be won by skill, and it takes all chips to win or lose the poker game, the outcome of the poker game is dependent on the playing skills of the first player and the second players.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of a skill based adaptation of a poker game.

FIG. 2 illustrates a system for a skill based adaptation of a poker game.

FIG. 3 illustrates an embodiment of the system as an online environment for the skill based adaptation of poker game.

### DETAILED DESCRIPTION OF THE INVENTION

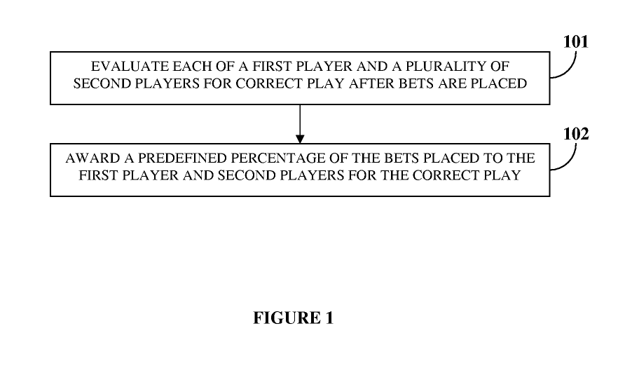

FIG. 1 illustrates a method of a skill based adaptation of a poker game. A skill component is introduced into the poker game by evaluating 101 each player of the poker game for correct play. Correct play may be evaluated at different stages of a poker game including after each player places a bet, after all players 201 have placed at least one bet, the end of each betting round of the poker game, etc. A first player is said to exhibit correct play if, regardless of the cards held by the first player, the first player makes the second players of the poker game fold. The first player may be any of the players 201 who makes the remaining players referred to as the second players fold. Correct play is also evaluated based on a player playing with a null or a positive expected value.

Expected value for each player is calculated based on bets placed by each of the players 201, probabilities of winning the poker game by the players 201, and the sum of bets placed by the players 201. On calculating the expected value for each player the players 201 are awarded 102 a predefined percentage of the bets placed as an incentive for correct play. The predefined percentage of the bets placed may be awarded to the players as skill chips. The poker game may continue for a predefined time or until one player has all the chips. Since some chips can only be won by skill, and it takes all chips to win or lose the poker game, the outcome of the poker game is dependent on playing skills of the players 201.

The expected value for each player is exemplarily calculated as outlined in the following equation:

Expected value=winPercentage*adjustedPot+(lossPercentage*(−amountPaid))

The expected value of a player is calculated as the difference of adjusted amount of bets collected and the bet amount of the player adjusted against the probability of the player winning, losing or tying the poker game. The “winPercentage” refers to the probability of the player winning the poker game and the “lossPercentage” refers to the probability of the player losing the poker game. The probability of the player winning or losing the poker game is calculated by enumerating all possible outcomes of the poker game or for example, by using the Monte Carlo method. The “adjustedpot” is the difference between the total amount of bets placed by all the players 201 and the bet amount placed by the player. The bet amount placed by the player is the “amountPaid”.

By awarding the players 201 a predefined percentage of the bets placed as an incentive for correct play, it is ensured that no player loses a poker game due to chance. For example, consider two players 201 Rachael and Jeff playing a texas hold'em poker game. Rachael is dealt a hand comprising a pair of aces (AA) and Jeff is dealt a hand comprising a pair of kings (KK). Rachael with AA bets a thousand chips. Jeff calls the bet made by Rachael. The community cards dealt is 2-3-4-Q-K. The percentage probability of Rachael winning or tying is computed to be 82% and the percentage probability of Jeff winning or tying is computed to be 18%. Correct play is evaluated for Rachael and Jeff. The expected value for Rachael is calculated as:

Expected Value=0.82*1000+(0.18*−1000)

Expected Value=820+(−180)

Expected Value=640

Rachael has a positive expected value for the hand dealt to her and so her bet is deemed to be correct. A predefined percentage of the bets placed is awarded to Rachael as skill chips for correct play. The expected value for Jeff is calculated as:

Expected Value=0.18*1000+(0.82*−1000)

Expected Value=180+(−820)

Expected Value=−640

Jeff has a negative expected value for the hand dealt to him. Jeff's play for the given hand is deemed incorrect. Rachael played perfectly as AA is over a 4:1 favorite to win, yet lost the game due of chance as Jeff was dealt a better hand. The skill chips awarded to Rachael for correct play and the fact that the game continues until one player has all the chips ensures that Rachael's result depends on her playing skills.

In one embodiment, the probability of a player winning, losing, or tying the poker game is calculated by enumerating all possible outcomes of the poker game. The probability of an outcome for a player is calculated by theoretically removing the cards dealt to the players 201 from the deck of cards. All possible combinations of community cards that may be dealt out of the remaining cards, during the course of the game, are listed. The probability of the players 201 winning, losing or tying for each possible combination of the community cards is evaluated and tracked. The total number of possible wins, losses, and ties of each player occurring due to the possible combinations of community cards is calculated. The probability of the players 201 winning, losing or tying the game is calculated based on the total number of possible wins, losses, and ties of the players 201.

For example, consider two players 201 Alice and Bob involved in a poker game. Alice is dealt a hand comprising a pair of aces (AA) and Bob is dealt a hand comprising a pair of kings (KK). Three of the five community cards are dealt. Out of the total 52 cards in the deck of cards there are 45 cards left after removing the cards dealt to Alice and Bob and the dealt community cards. From the remaining 45 cards the two card permutations possible for dealing the two community cards are 45*44 and if the order of the two card combinations is irrelevant, for example if “AK” is considered the same as “KA” then the number of two card combinations reduces to 990. The probability of Alice or Bob winning, losing, or tying for each of the possible two community card combinations is determined and compared against 990 to obtain winning, losing and tying probabilities for each player.

In another embodiment, the probability of the players 201 winning, losing or tying the poker game is determined by iterating over random outcomes of the game for a predefined number of times. Exemplarily, the Monte Carlo method is used for calculating the players' 201 probability using random outcomes of the game. The Monte Carlo method involves defining a domain of possible combinations of community cards, generating random combinations of the community cards from the domain of possible combinations and performing a deterministic computation on the random combinations over a predefined number of iterations. The outcomes over the number of iterations are then aggregated to calculate the players' 201 probability of winning, losing or tying the game.

Consider multiple players 201 participating in a poker game. The Monte Carlo method of calculating the probability of winning, losing or tying for each player involves theoretically removing all the cards dealt to the players 201 from the deck of cards and defining a domain of possible combinations of community cards comprising the remaining cards. Random combinations of the community cards are generated from the domain of possible combinations and the probabilities of the players 201 winning, losing or tying based on each random combination of community cards are evaluated. A number of iterations are performed utilizing different random combinations of community cards. The final result is determined by tracking the wins, losses and ties of each player over the iterations. The Monte Carlo method randomly generates outcomes. When these outcomes are tracked over a number of iterations the final results are fairly accurate.

The winPercentage of a player calculated by the Monte Carlo method is exemplarily calculated as outlined in the following equation:

winPercentage=(number of ties/number of iterations)+(number of wins/number of iterations).

For example, consider two players 201 Bob and Tom in a poker game. Bob is dealt a king of clubs and a jack of diamonds and Tom is dealt a three of clubs and a four of clubs. The Monte Carlo algorithm is used to determine the wins, ties and losses of Bob and Tom before the community cards are dealt. The win, tie, and loss statistics of Bob and Tom after a number of iterations, for example 50,000 iterations, using random combinations of community cards are:

Bob's statistics:

Wins=30610

Ties=403

Losses=18987

Tom's statistics:

Wins=18987

Ties=403

Losses=30610

The winPercentage for Bob and Tom is calculated as:

Bob's winPercentage:

winPercentage=(number of ties/number of iterations)+(number of wins/number of iterations)

winPercentage=(403/50000)+(30610/50000)

winPercentage=31013/50000

winPercentage=0.62026

winPercentage≅62%

Tom's winPercentage:

winPercentage=(number of ties/number of iterations)+(number of wins/number of iterations)

winPercentage=(403/50000)+(18987/50000)

winPercentage=19390/50000

winPercentage=0.3878

winPercentage≅38.8%

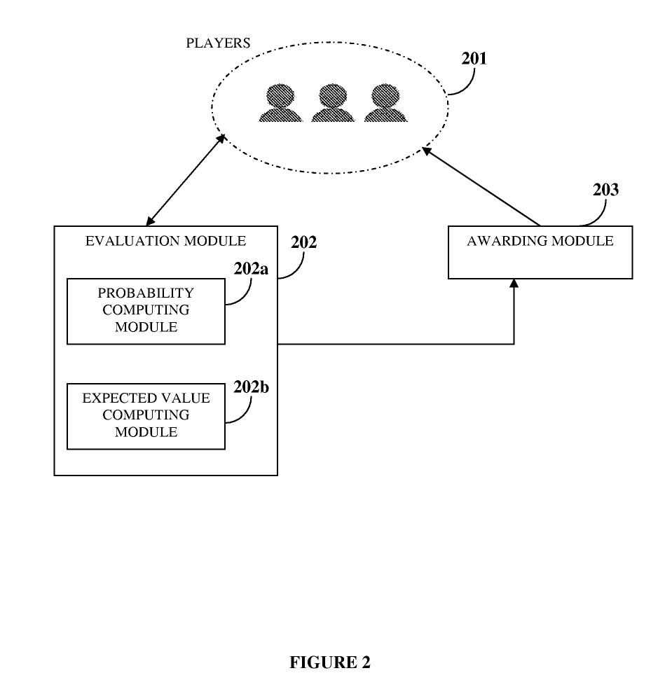

FIG. 2 illustrates a system for a skill based adaptation of a poker game. The system disclosed herein comprises an evaluation module 202 and an awarding module 203. The evaluation module 202 evaluates each player of the poker game for correct play after bets are placed. The evaluation module 202 comprises a probability computing module 202a for computing probability of winning, losing or tying the poker game for each player and an expected value computing module 202b for computing the expected value of a player based on the probability computed by the probability computing module 202a.

The awarding module 203 awards a predefined percentage of the bets placed to the player as an incentive for correct play. The player may be awarded a predefined percentage of the bets placed by the player or a predefined percentage of the bets placed by all the players 201.

The evaluation module 202 may be for example, a portable hand held device given to the players 201. Information regarding the probabilities of a player winning, losing or tying at each stage of the game may be used by the players 201 to make informed decisions and make corrections in their strategy to ensure profits in the long run.

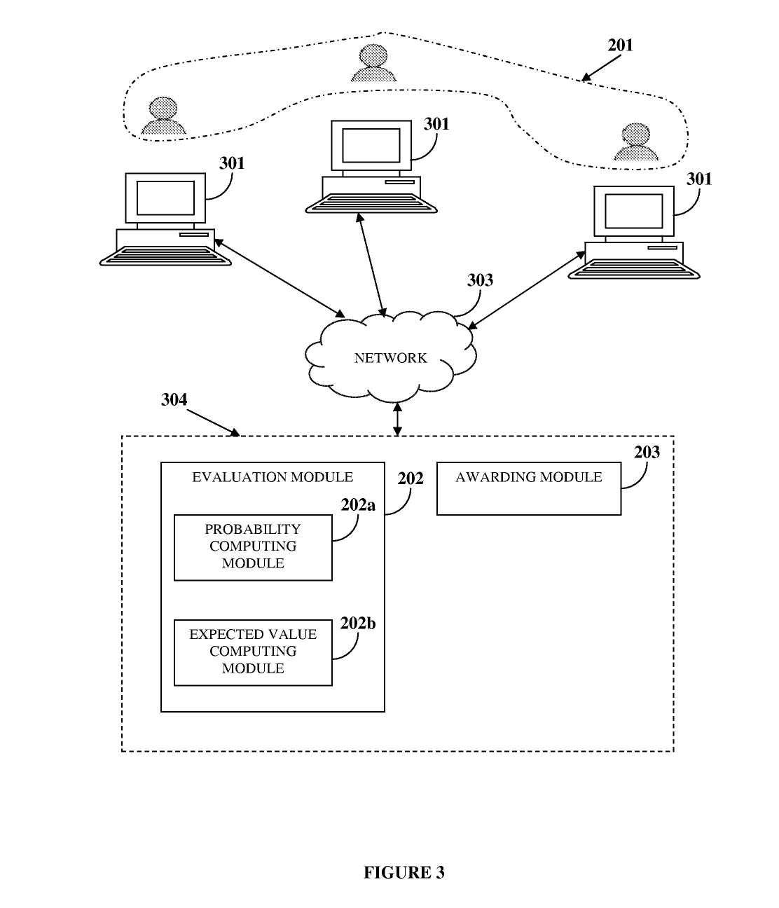

FIG. 3 illustrates an example of an online environment for a skill based adaptation of a poker game. Each of the players 201 participates in an online poker game on an online poker environment 304. The players 201 access the online poker environment 304 using a computing terminal 301 via a network 303. The computing terminal 301 may be one of, but not limited to, a personal computer, a laptop, a personal digital assistant, a mobile device enabled with internet capabilities, etc. The online poker environment 304 comprises an evaluation module 202. The evaluation module 202 comprises a probability computing module 202a and an expected value computing module 202b. The function and working of these modules are as described in the detailed description of FIG. 2. The players 201 play online poker by placing bets online. The players 201 are evaluated for correct play after the bets are placed by the evaluation module 202 and are awarded a predefined percentage of bets placed as an incentive for the correct play by the awarding module 203.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product, comprising computer executable instructions embodied in a computer-readable medium, comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of a skill based adaptation of a poker game comprising the steps of:
evaluating each of a first player and a plurality of second players of said poker game for correct play after bets are placed, wherein said correct play of said first player and said second players comprises:
making the second players of the poker game fold by the first player;
playing with one of a null and a positive expected value, wherein said expected value is calculated based on bets placed by each of the first player and the second players, probability of winning the poker game by the first player and the second players, and sum of said bets placed; and
awarding a predefined percentage of the bets placed to the first player and the second players for the correct play;
whereby the step of awarding the first player and the second players for the correct play ensures the outcome of the poker game is dependent on playing skills of the first player and the second players.

2. The method of claim 1, wherein the poker game continues for a predefined amount of time.

3. The method of claim 1, wherein the poker game continues until a player wins all chips.

4. The method of claim 1, wherein the expected value of a player is calculated as difference of adjusted amount of bets collected and the bet amount of said player adjusted against said probability of the player winning and losing the poker game, wherein said adjusted amount is difference between total bets collected and the bet amount placed by the player.

5. The method of claim 1, wherein said probability of winning the poker game by the first player and the second players is calculated by:
enumerating each possible combination of community cards of the poker game after player cards are dealt, wherein said community cards are dealt face up and shared by the first player and the second players;
evaluating results for the first player and the second players based on each of said combinations of the community cards along with said player cards dealt, wherein said results comprises wins, losses, and ties;
tracking the results of the first player and the second players; and
comparing the results of the first player and the second players with total possible combinations.

6. The method of claim 1, wherein said probability of winning the poker game by the first player and the second players is calculated by performing a plurality of iterations with random outcomes of the poker game, wherein each of said iterations comprise:
randomly generating a combination of community cards after player cards are dealt; and
evaluating results for the first player and the second players based on said cards dealt and said randomly generated combination of community cards.

7. The method of claim 6, further comprising tracking of said results for each of the iterations.

8. A system for a skill based adaptation of a poker game comprising:
an evaluation module for evaluating each of a first player and a plurality of second players of said poker game for correct play after bets are placed, comprising:
a probability computing module for computing probability of winning the poker game by said first player and said second players;
an expected value computing module for computing expected value of the first player and the second players based on said probability; and
an awarding module for awarding a predefined percentage of bets to the first player and the second players for said correct play.

9. A computer program product comprising computer executable instructions embodied in a computer-readable medium, wherein said computer program product comprises:
a first computer parsable program code for computing probability of winning a poker game by a first player and a second players of said poker game;
a second computer parsable program code for computing expected value of said first player and said second players based on said probability of winning a poker game by the first player and the second players; and
a third computer parsable program code for calculating a predefined percentage of the bets placed to be awarded to the first player and the second players for correct play.
